(19) United States
(12) Patent Application Publication
(10) Pub. No.: US 2015/0146072 A1
(43) Pub. Date: May 28, 2015

(54) IMAGE FOCUSING

(71) Applicants: Bo Larsson, Malmo (SE); Mats Wernersson, Helsingborg (SE)

(72) Inventors: Bo Larsson, Malmo (SE); Mats Wernersson, Helsingborg (SE)

(73) Assignee: SONY MOBILE COMMUNICATIONS AB, Lund (SE)

(21) Appl. No.: 14/112,784

(22) PCT Filed: Apr. 19, 2012
(86) PCT No.: PCT/EP2012/001713

§ 371 Date: Oct. 18, 2013

(51) Int. Cl. H04N 5/232; G06T 7/00

(52) U.S. Cl. CPC H04N 5/23216; G06T 7/0051
USPC 348/333.08

(57) ABSTRACT

A device is provided, wherein a focus plane may be selected via a user input (33, 34). The selected focus plane is highlighted to enable a user to select a desired focus plane easily.

### FIELD OF THE INVENTION

The present invention relates to focusing, i.e., setting a focus plane, in images which may be captured by light field cameras and to corresponding devices.

### BACKGROUND OF THE INVENTION

In conventional cameras, an image of a scene to be captured is reproduced on an image sensor, for example a CCD sensor a CMOS sensor, via a lens. The lens may be a so called fixed focus lens where a focus plane has a fixed distance from the lens or may be a variable focus lens where the position of the focus plane may be varied. Objects in or adjacent to the focus plane appear “sharp” in the image captured by the image sensor, while objects outside or farther away from the focus plane appear more or less blurred. Depending on an aperture used, an area where objects appear sharp in the captured image may extend to some distance on both sides of the focus plane, also referred to as depth of field (DOF). In such a conventional camera, the position of the focus plane and the sharpness of the recorded image may only be influenced by post processing in a very limited manner. It should be noted that depending on the lens used, the focus plane need not be an actual plane, but may also be curved.

A new type of camera which has been developed and researched in recent years is the so called light field camera, which is one type of a so-called computational camera. In light field cameras, the image is not directly reproduced on the image sensor, such that essentially, apart of operations like demosaicing and sharpening, the output of the image sensor directly shows the captured scene, but light rays from the scene in light field cameras are guided to an image sensor in an unconventional manner. For example, light rays originating from a single object in the scene to be captured may be guided to different locations remote from each other on an image sensor, which corresponds to viewing the object from different directions. To this end, for example a conical mirror may be arranged in front of a lens. In other implementations, an optic used for guiding light from a scene to be recorded to the image sensor may be variable, for example by varying geometric or radiometric properties. Such a variable optic may for example comprise a two-dimensional array of micro mirrors which have controllable orientations.

Unlike conventional cameras, in light field cameras a more sophisticated processing of the data captured by the image sensor is necessary to provide the final image. On the other hand, in many cases there is a higher flexibility in setting parameters like focus plane of the final image.

However, in particular on small displays like typical camera displays or displays of other devices incorporating cameras, for example displays of mobile phones incorporating a camera, it may be difficult for a user to set a desired focus plane of the final image correctly. Similar problems may occur with the setting of a focus plane in other situations, e.g. when conventional images and a depth information are provided. Therefore, there is a need for aiding a user to set a focus plane in an image captured by a computational camera.

### SUMMARY

A method as defined in claim 1 and a device as defined in claim 9 are provided. The dependent claims define further embodiments.

According to an embodiment, a method is provided, comprising:

providing at least one image,

providing depth information for the at least one image,

displaying the image,

selecting a focus plane, and

highlighting the selected focus plane in the displayed image.

Providing the at least one image and the depth information may comprise capturing an image with a computational camera, e.g. a light field camera.

According to an embodiment, highlighting said selected focus plane may comprise coloring said selected focus plane in said displayed image.

According to an embodiment, selecting the focus plane may be based on a user input.

According to an embodiment, the method may further comprise providing a slider to enable the user to select the focus plane.

According to an embodiment, the method may further comprise generating a final image with the selected focus plane based on the at least one image.

According to an embodiment, the method may further comprise selecting a depth of field for the final image.

According to an embodiment, the method may further comprise generating the final image based on the selecting depth of field.

According to a further aspect, a device is provided, comprising:

an image sensor configured to capture an image,

a user input to enable a user to select a focus plane for an image, and

a display configured to display the image with the selected focus plane highlighted.

The device may further comprise a light flied camera for capturing the image.

According to an embodiment, said display may comprise a touchscreen, and wherein said user interface comprises a slider on said touchscreen.

The device may be configured to perform any one of the methods described above.

### BRIEF DESCRIPTION OF THE DRAWINGS

FIG. 1 illustrates a camera device according to an embodiment.

FIG. 2 is a flowchart illustrating a method according to an embodiment.

FIGS. 3A-3C are example images for illustrating some operations performed in the embodiment of FIG. 2.

### DETAILED DESCRIPTION

In the following, various embodiments of the present invention will be described in detail. It should be noted that features of different embodiments may be combined with each other unless noted otherwise. On the other hand, describing an embodiment with a plurality of features is not to be construed as indicating that all those features are necessary for practicing the invention, as other embodiments may comprise less features and/or alternative features. Generally, the embodiments described herein are not to be construed as limiting the scope of the present application.

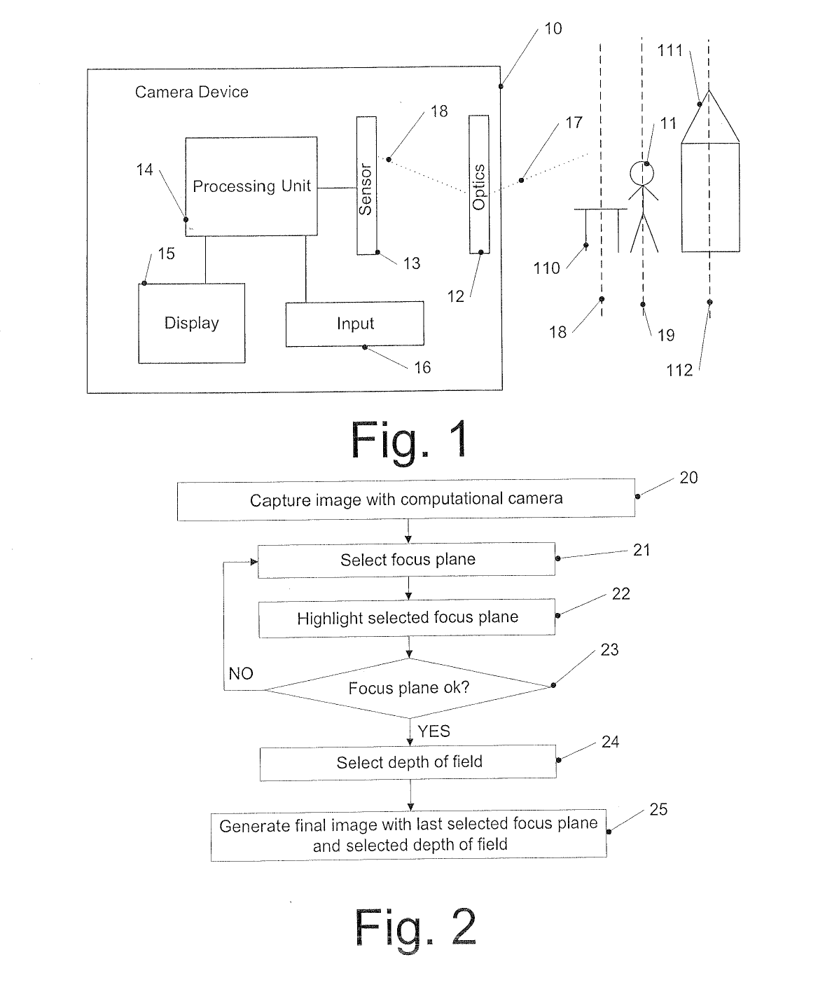

In FIG. 1, a camera device 10 according to an embodiment is shown. Camera device 10 may be a dedicated camera, but may also be any other device incorporating a camera, for example a mobile phone or smartphone incorporating a camera, a personal digital assistant (PDA) incorporating a camera or a computer like a laptop computer or a tablet PC incorporating a camera. In FIG. 1, only those components relating to camera operation according to embodiments are shown. Other components, for example components for providing mobile telephony capabilities in case camera device 10 is a mobile phone, may also be present and be implemented in any conventional manner.

Camera device 10 is configured as a light field camera device, i.e. a type of computational camera. To this end, camera device 10 comprises optics 12 for guiding light rays like a light ray 17 from a scene to be captured, in the example a person 11, a table 110 and a house 111 to a sensor 13. Optics 12 do not reproduce the image directly on the sensor, but as explained in the introductory portion, guide the light rays from the scene to be taken to sensor 13 in an “unconventional” manner. For example, light ray 17 may be guided to sensor 13 as light ray 18.

To this end, besides one or more lenses or optics 12 may comprise other elements like a conical mirror or a micro mirror arraignment with controllable mirrors. Other types of light modulators or mirrors may as well be included in optics 12.

Sensor 13 may be any conventional image sensor like a CMOS sensor or a CCD sensor. For recording of color images, sensor 13 may have a color filter in front of the sensor, for example a color filter using the so called Bayer pattern, as conventionally used in digital cameras. In other embodiments, sensor 13 may comprise different layers for recording different colors. In still other embodiments, sensor 13 may be configured to record monochrome images.

An output of sensor 13 is supplied to processing unit 14 for processing the signals from the sensor to generate an image of the recorded scene, which then may be displayed on display 15, which for example may be a LCD or LED screen of camera device 10. Furthermore, camera device 10 comprises an input 16 to allow a user to control camera device 10. Input device 16 may for example comprise buttons, joysticks, a keypad or a device configured to interpret gestures of the user. In some embodiments, display 15 may be a touchscreen, and in this case input device 16 may also comprise display 15 to enable inputs via gestures on the touchscreen provided as display 15.

As will be explained in the following, processing unit 14, based on inputs received from input device 16, may highlight a focus plane in the image. Such highlighting facilitates selection of a desired focus plane. After the desired focus plane is selected, in some embodiments in addition a desired depth of field may be selected, and an image may then be generated based on the selected focus plane and the selected depth of field. It should be noted that the selection of a focus plane is not to be construed as indicating that only a single focus plane may be selected, as in some embodiments also more than one focus plane may be selected.

As an example, camera device 10 of FIG. 1 records a scene comprising a person 11, a table 110 and a house (in the background) 111. The various items are not drawn to scale, but are merely intended as an illustration. If the focus plane for example is set to a plane 19, person 11 appears focused, if the focus plane is set on a plane 18, table 110 appears focused, and if the focus plane is set on a plane 112, house 111 appears focused. As will be explained in the following in more detail, for example by using a slider on a touchscreen or another input element provided by input device 16, a user, after recording of the image, may browse through possible focus planes, and a certain selected focus plane as indicated above is highlighted to facilitate the final selection.

It should be noted that depending on the light field camera used a number of different focus planes actually selectable may vary. In some cases, possible, i.e. selectable focus planes at a closer distance may be more densely spaced than possible focus planes farther away from the respective camera device.

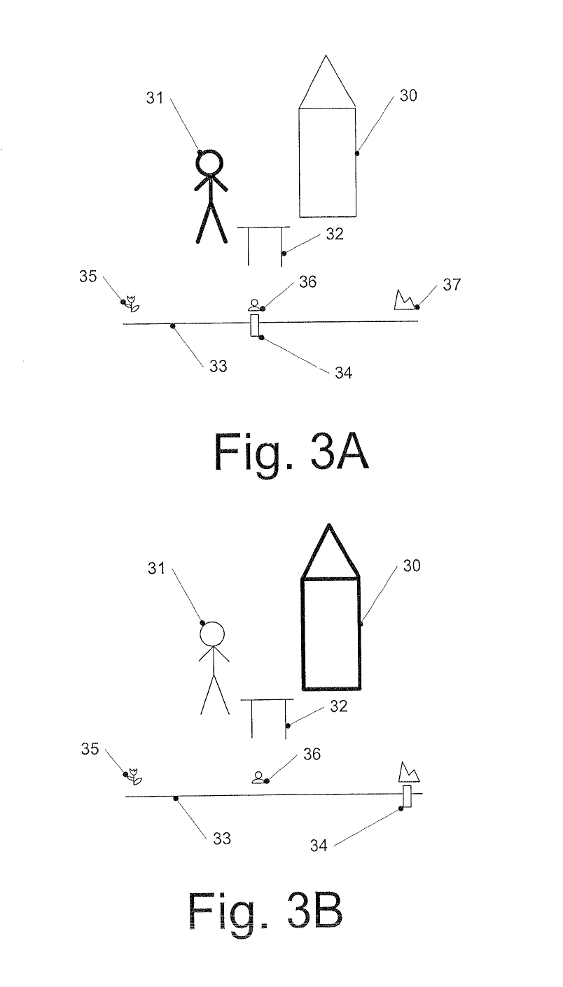

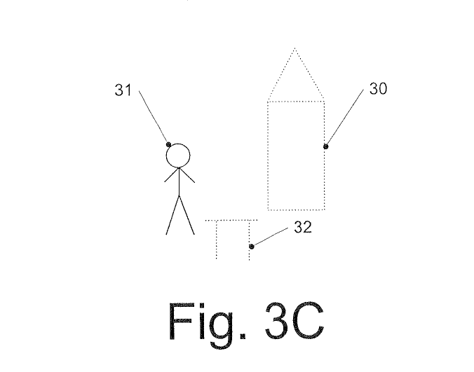

An embodiment of a corresponding method will now be described with reference to FIGS. 2 and 3. FIG. 2 shows a flowchart illustrating a method according to an embodiment. The method of FIG. 2 may be implemented for example in the camera device of FIG. 1, but may also be used independently therefrom in particular in connection with other light field camera devices. FIGS. 3A-3C, collectively referred to as FIG. 3, show example scenes and images to illustrate some operations performed in the embodiment of FIG. 2. It should be noted that the example images of FIG. 3 serve only for illustration and are in no way construed to limit the present invention to the kind of scene or image shown in this figure, as principles of the present invention may be applied to virtually any scene or image captured by a light field camera.

At 20 in FIG. 2, an image is captured with a computational camera, for example a light field camera, for example camera device 10 of FIG. 1 or any other light field camera device. At 21 a focus plane is selected by a user using a corresponding input device like input device 16, which may also be implemented on a touchscreen. At 22, on a display the selected focus plane is highlighted, for example by giving a specific color to the selected focus plane. It should be noted that the focus plane in this respect is not necessarily a plane in the mathematical sense, but may have a certain extension perpendicular to the plane, i.e. all elements of the image within the thus extended focus plane may be highlighted. At 23, it is checked if the selected focus plane is OK. If not, the method goes back to 21 to select a different focus plane followed by highlighting at 22, until at 23 the selected focus plane is approved by a user.

As an example for this, FIGS. 3A and 3B depict an image of a scene corresponding to the scene of FIG. 1, with a person 31, a table 32 and a building 30. In this example, in the scene corresponding to the image building 30 is in the background, table 32 is closest to the camera and person 31 is rather in the middle.

On a display, together with this image a slider scale 33 with a slider 34 is shown. By user input, for example by touching and moving slider 34 on a touchscreen or for example by operating a joystick or keys provided, slider 34 may be moved along slider scale 33. The left side of slider scale 33, marked by a flower 35, corresponds to a close up (or even macro) distance. The right end, marked by a mountain 37, essentially corresponds to a focus of infinity. A person 36 marks the focus for typical images taken from persons, for example distances in the range of two meters to five meters.

In the example of FIG. 3A, slider 34 is set to a middle range corresponding to the distance to person 31. In other words, the focus plane is set to a plane corresponding to the position of person 31, which in the example of FIG. 1 would for example correspond to plane 19 for person 11. Consequently, person 31 is highlighted in the image so that a user, even on a small display, immediately recognizes which portion of the image would appear focused in the final image with this focus plane setting. While in FIG. 3A the highlighting being marked with thicker lines, in some embodiments the highlighting is performed by a specific coloring, preferably in a color which has some signal characteristics like neon green, bright yellow etc, such that the elements of the scene which are in focus are immediately recognizable.

To give another example, in FIG. 3B slider 34 is set essentially to the infinity position. Here, the focus plane corresponds to a distance of building 30 (for example like focus plane 112 for building 111 of FIG. 1), such that in this case building 30 is highlighted. It should be noted if several objects are located in the corresponding distance (for example several buildings in the background, a person with another object like a dog in the middle ground etc), all of these objects which correspond to the selected focus distance or focus plane may be highlighted.

Once the selected focus plane finds the approval of the user (yes at 23 in FIG. 2), at 24 optionally in addition a depth of field may be selected, i.e. an “extension” of the focused area in a direction perpendicular to the focus plane. For example, for portrait photography it is generally desired that a face of the portrayed person is focused, but other areas of the image are out of focus and therefore blurred, while for example in landscape photography a more extended depth of field may be desirable. The selected depth of field may be directly shown on a display such that a user immediately can evaluate if she/he is pleased with the selected depth of field. For example, in FIG. 3C a depth of field is selected such that only person 31 is focused (for example after having selected the focus plane as shown in FIG. 3A), but table 32 and building 30 are out of focus (represented by dotted lines in FIG. 3C).

It should be noted that in some embodiments, the width of the highlighted portion, i.e. the extension of the focus plane in a direction perpendicular thereof for highlighting purposes, may be a fixed value or a user configurable value. In other embodiments, this value may increase with increasing distance from the camera, thus resembling the behaviour of conventional lenses for cameras where the extension of the depth of field, i.e. the focused area, increases with increasing distance.

In other embodiments, highlighting may for example comprise a blinking of the elements of the image associated with the selected focus plane, a marking by marking elements like dots on the screen or any other highlighting suitable for marking the selected focus plane discernable from other planes.

It should be noted that in some embodiment, the selection of the depth of field may be omitted. In still other embodiments, the depth of field additionally or alternatively may be selected prior to selecting the focus plane. In still other embodiment, more than one focus plane may be selected in the manner described above.

In still other embodiments, images from other sources than light field cameras or other computational cameras may be used. For example, the actions described with reference to 21-25 in FIG. 2 may be performed with any image or plurality of images for which depth information like a depth map, i.e. information which describes the distance of each part of the image from a certain view point, is provided. These actions then may be implemented for example in a processing unit as shown in FIG. 14, and the image and depth information may be delivered in any desired manner, for example on a data carrier or via network.

Such images may for example comprise an image recorded with a conventional camera, for example captured with an aperture leading to a large depth of view. Depth information may additionally be provided using a depth scanning device, for example an infrared laser scanner. In some embodiments, then within the depth of field a focus plane may be selected, and image portions outside that focus plane may be artificially blurred by image processing. In still other embodiments, a plurality of images with different focus planes may be provided, and selecting the focus plane in the manner described above may then ultimately lead to the selection of one of these images. The depth information in such a case may be represented by the different focus distances of the different images.

Therefore, the above-described embodiments are not to be construed as limiting, but are to be taken as illustrative examples only.

1-12. (canceled)

13. A method, comprising:
providing at least one image,
providing depth information for the at least one image,
displaying an image of the at least one image,
selecting a focus plane, and
highlighting the selected focus plane in the displayed image.

14. The method of claim 13, wherein highlighting said selected focus plane comprises coloring said selected focus plane in said displayed image.

15. The method of claim 13, wherein selecting the focus plane is based on a user input.

16. The method of claim 15, further comprising providing a slider to enable the user to select the focus plane.

17. The method of claim 13, further comprising generating a final image with the selected focus plane based on the at least one image.

18. The method of claim 17, further comprising selecting a depth of field for the final image.

19. The method of claim 18, further comprising generating the final image based on the selected depth of field.

20. The method of claim 13, wherein providing at least one image and providing depth information for the at least one image comprises capturing an image with a light field camera.

21. A device, comprising:
a user input to enable a user to select a focus plane for an image, and
a display configured to display the image with the selected focus plane highlighted.

22. The device of claim 21, wherein said display comprises a touchscreen, and wherein said user interface comprises a slider on said touchscreen.

23. The device of claim 21, further comprising a light field camera for capturing the image.

24. The device of claim 21, wherein highlighting said selected focus plane comprises coloring said selected focus plane in said displayed image.

25. The device of claim 21, wherein said device is configured to generate a final image with the selected focus plane based on the image.

26. The device of claim 25, wherein said user input is configured to enable a user to select a depth of field for the final image.

27. The device of claim 25, wherein said device is configured to generate the final image based on the selected depth of field.
